(19) United States
(12) Patent Application Publication
(10) Pub. No.: US 2025/0162351 A1
(43) Pub. Date: May 22, 2025

(54) PNEUMATIC TIRE

(71) Applicant: Sumitomo Rubber Industries, Ltd., Kobe-shi (JP)

(72) Inventor: Hiroaki NINOMIYA, Kobe-shi (JP)

(73) Assignee: Sumitomo Rubber Industries, Ltd., Kobe-shi (JP)

(21) Appl. No.: 18/934,476

(22) Filed: Nov. 1, 2024

(30) Foreign Application Priority Data
Nov. 22, 2023 (JP) 2023-198537

(51) Int. Cl. B60C 11/00; B60C 11/03

(52) U.S. Cl. CPC B60C 11/0008; B60C 2011/0016; B60C 2011/0341

(57) ABSTRACT

A pneumatic tire has a tread portion including a tread rubber forming a ground contact surface, a belt layer, and an outer diameter from 350 to 600 mm, and is configured to be mounted on a tire rim having a rim width RW from 78% to 99% of a tire section width SW of the pneumatic tire. The ground contact surface is divided into a plurality of land regions including shoulder land regions by circumferential grooves provided in the tread portion. In an axial half of the pneumatic tire, the shoulder land region has an inner edge located axially inside an outer edge of the belt layer, and a distance LA between the inner edge and the outer edge is from 10% to 30% of a maximum belt width WA of the belt layer. A hardness Hs of the tread rubber satisfies Expression 1:

Hs≤75−20×LA/SW (Expression 1).

### RELATED APPLICATIONS

This application claims the benefit of foreign priority to Japanese Patent Applications No. JP2023-198537, filed Nov. 22, 2023, which is incorporated by reference in its entirety.

### FIELD OF THE INVENTION

The present disclosure relates to a pneumatic tire having a tread portion.

### BACKGROUND OF THE INVENTION

Conventionally, small-diameter pneumatic tires suitable for use on small shuttle buses and the like are known. Japanese unexamined patent application publication No. 2023-102627 (Patent Document 1) has proposed a pneumatic tire with improved durability performance in bead portions, where strain is concentrated due to the small diameter, for example.

### SUMMARY OF THE INVENTION

However, small-diameter pneumatic tires used for heavy vehicles such as those described in the Patent Document 1 have a short ground contact length and a wide ground contact width, i.e., a so-called wide ground contact patch shape, and there has been room for improvement in ride comfort performance due to issues such as the dispersion of road surface input, input sensitivity, and frequency.

The present disclosure was made in view of the above, and a primary object thereof is to provide a wide, small-diameter pneumatic tire capable of improving the ride comfort performance.

The present disclosure is a pneumatic tire configured to be mounted on a tire rim having a rim width RW, and including:
a tread portion;
a tire section width SW; and
an outer diameter from 350 to 600 mm,
wherein the tread portion includes a tread rubber forming a ground contact surface and having a hardness Hs, a belt layer disposed radially inside the tread rubber, and at least two circumferential grooves extending continuously and linearly in a tire circumferential direction,
the rim width RW is in the range from 78% to 99% of the tire section width SW,
the belt layer has outer edges in the tire axial direction, one outer edge on each axial side, and a maximum belt width WA in the tire axial direction,
the ground contact surface is divided into a plurality of land regions by the circumferential grooves,
the land regions include a pair of shoulder land regions each located on a respective axially outermost side,
each of the shoulder land regions includes an inner edge in the tire axial direction,
in an axial half of the pneumatic tire, the inner edge of the shoulder land region is located axially inside the outer edge of the belt layer,
in an axial half of the pneumatic tire, a distance LA in the tire axial direction between the inner edge of the shoulder land region and the outer edge of the belt layer is in the range from 10% to 30% of the maximum belt width WA of the belt layer,
the hardness Hs of the tread rubber satisfies the following Expression 1:

$$Hs \leq 75 - 20 \times \frac{LA}{SW} , \qquad ( Expression 1 )$$

where LA is a distance in millimeters between the inner edge of the shoulder land region and the outer edge of the belt layer in an axial half of the pneumatic tire, and
SW is the tire section width in millimeters.

It is possible that the pneumatic tire of the present disclosure improves ride comfort performance by having the configuration described above.

### BRIEF DESCRIPTION OF THE DRAWINGS

FIG. 1 is a cross-sectional view of a pneumatic tire according to an embodiment of the present disclosure.

FIG. 2 is an enlarged cross-sectional view of the tread portion.

### DETAILED DESCRIPTION OF THE INVENTION

An embodiment of the present disclosure will now be described in conjunction with accompanying drawings.

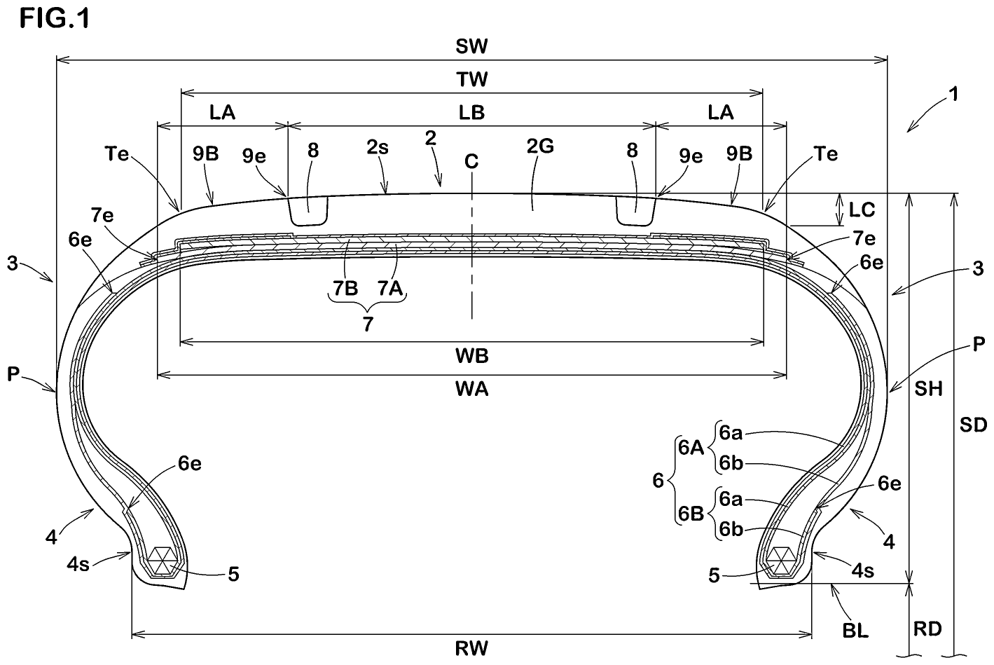

FIG. 1 is a tire meridian section of a pneumatic tire 1 according to the present embodiment in a standard state. The term “standard state” refers to a state in which the pneumatic tire 1 is mounted on a standard rim, inflated to a standard inner pressure, and loaded with no tire load. Hereafter, unless otherwise mentioned, dimensions and the like of various parts of the pneumatic tire 1 are the values measured in this standard state.

In the presence of a standardization system including a standard on which the pneumatic tire 1 is based, the term “standard rim” refers to a wheel rim specified for the concerned tire by a standard included in a standardization system on which the tire is based, for example, the “normal wheel rim” in JATMA, “Design Rim” in TRA, and “Measuring Rim” in ETRTO. In the absence of the standardization system including the standard on which the pneumatic tire 1 is based, the “standard rim” is a rim with the smallest rim diameter RD and the smallest rim width RW among rims that can be assembled with the pneumatic tire 1 and do not cause air leakage.

In the presence of a standardization system including a standard on which the pneumatic tire 1 is based, the “standard inner pressure” refers to air pressure specified for the concerned tire by a standard included in a standardization system on which the tire is based, for example, the maximum air pressure in JATMA, the maximum value listed in the “TIRE LOAD LIMITS AT VARIOUS COLD INFLATION PRESSURES” table in TRA, and “INFLATION PRESSURE” in ETRTO. In the absence of the standardization system including the standard on which the pneumatic tire 1 is based, the “standard inner pressure” is an air pressure set by the manufacturer and the like for each tire.

As shown in FIG. 1, the pneumatic tire 1 in the present embodiment has a small diameter and has a so-called wide ground contact surface shape with a short ground contact length and a wide ground contact width. When used in small buses and low-floor electric vehicles, the pneumatic tire 1 configured as such can increase the interior space of the vehicle and the space inside the rim, and thus can improve transportation efficiency and accommodating larger brakes, larger in-wheel motors, and the like.

It is preferred that the pneumatic tire 1 has an outer diameter SD from 350 to 600 mm. Since the outer diameter SD of the pneumatic tire 1 is 350 mm or more, the space inside the rim can be secured. The outer diameter SD of the pneumatic tire 1 is 600 mm or less, which helps to increase the interior space of a small bus, a low-floor electric vehicle, and the like.

The rim width RW of the rim on which the pneumatic tire 1 is mounted is from 78% to 99% of a tire section width SW. The rim width RW is the width between a pair of outer surfaces (4s) in the tire axial direction at radially inner portions of the pneumatic tire 1 in the standard state.

Since the rim width RW is 78% or more of the tire section width SW, a large volume can be secured for the tire inner cavity, which helps to improve the ride comfort performance. The rim width RW is 99% or less of the tire section width SW, which helps to support heavy loads such as small buses and low-floor electric vehicles.

The pneumatic tire 1 has a tread portion 2, a pair of sidewall portions 3, and a pair of bead portions 4. The sidewall portions 3 are portions extending radially inward from the tread portion 2 on both sides in the tire axial direction, for example. The bead portions 4 are the portions located radially inside the sidewall portions 3, for example.

Each of the bead portions 4 has an annular bead core 5 extending in the tire circumferential direction, for example. The bead core 5 is formed from steel wires, for example. Here, the above-mentioned outer surfaces (4s) in the tire axial direction at the radially inner portions of the pneumatic tire 1 are the outer surfaces (4s) in the tire axial direction of the bead portions 4.

It is preferred that the pneumatic tire 1 includes a carcass 6 extending between the bead portions 4 and a belt layer 7 arranged in the tread portion 2. The tread portion 2 in the present embodiment includes a tread rubber 2G forming a ground contact surface (2s), the belt layer 7 disposed radially inside the tread rubber 2G, and the carcass 6 disposed radially inside the belt layer 7.

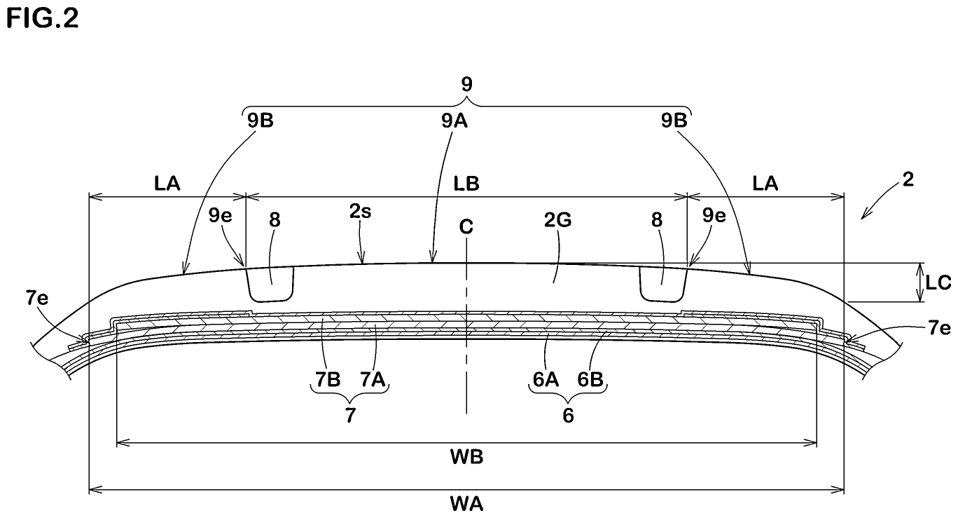

FIG. 2 is an enlarged cross-sectional view of the tread portion 2. As shown in FIG. 2, the ground contact surface (2s) is divided into a plurality of land regions 9 by at least two circumferential grooves 8, two circumferential grooves 8 in the present embodiment, each extending continuously and linearly in the tire circumferential direction on the tread portion 2. It should be noted that the number of the circumferential grooves 8 is not limited to two, but it is preferred that the tread portion 2 is provided with 2 to 4 circumferential grooves 8 in order to ensure a sufficient ground contacting area of the land regions 9 for supporting a heavy load.

The land regions 9 include at least a crown land region 9A located on the axially inner side (on the tire equator (C) in the present embodiment), and a pair of shoulder land regions 9B each located on the axially outermost side among the land regions 9 in a respective axial half of the pneumatic tire 1, ie., one shoulder land region 9B on each axially outermost side, for example. Each of the shoulder land regions 9B in the present embodiment has an inner edge (9e) in the tire axial direction.

Each of the inner edges (9e) in the present embodiment is located axially inside a respective one of outer edges (7e) in the tire axial direction of the belt layer 7. Since the shoulder land regions 9B configured as such are reinforced by the belt layer 7, the shoulder land regions 9B can exhibit high rigidity and thus are suitable for supporting heavy loads.

As shown in FIG. 1 and FIG. 2, in each axial half of the pneumatic tire 1, it is preferred that a distance LA in the tire axial direction between the inner edge (9e) and outer edges (7e) axially adjacent to each other is from 10% to 30% of a maximum belt width WA in the tire axial direction of the belt layer 7.

In each axial half of the pneumatic tire 1, since the distance LA between the inner edge (9e) and the outer edge (7e) is 10% or more of the maximum belt width WA, the rigidity of each shoulder land region 9B is increased, which makes it possible to support heavy loads. Since the distance LA between the inner edge (9e) and the outer edge (7e) is 30% or less of the maximum belt width WA in each axial half of the pneumatic tire 1, the rigidity of each shoulder land region 9B is prevented from becoming excessively large, therefore, it is possible that the ride comfort performance during cornering is improved.

A hardness (Hs) of the tread rubber 2G in the present embodiment satisfies the following Expression 1.

$$Hs \leq 75 - 20 \times \frac{LA}{SW} \qquad ( Expression 1 )$$

where LA is the distance in millimeters between the inner edge (9e) and the outer edge (7e) in an axial half of the pneumatic tire, and

SW is the tire section width in millimeters.

Here, the hardness (Hs) of the tread rubber 2G is a hardness measured by a type-A durometer in an environment of 23 degrees Celsius in accordance with Japanese Industrial Standard JIS-K6253. It should be noted that the tire section width SW is a distance in the tire axial direction between a pair of tire maximum width positions (P) in the tire profile excluding convexities that protrude locally from the tire surface.

The hardness (Hs) of the tread rubber 2G has an upper limit set in relation to the structural rigidity of the shoulder land regions 9B according to Expression (1). The tread rubber 2G configured as such can reinforce the shoulder land regions 9B when the structural rigidity is low, and can mitigate the impact force acting on the shoulder land regions 9B when the structural rigidity is high. Thereby, it is possible that the pneumatic tire 1 in the present embodiment improves the ride comfort performance for a wide, small-diameter tire capable of supporting a heavy load.

In a more preferred embodiment, the outer edge (7e) of the belt layer 7 is positioned axially outside a tread edge (Te) in each axial half of the pneumatic tire 1. In other words, it is preferred that the maximum belt width WA is larger than a tire tread width TW. The belt layer 7 configured as such can increase the rigidity of the entire ground contact surface (2s) of the tread portion 2 and is suitable for supporting high loads.

Here, the tread edges (Te) are the axially outermost ground contacting positions of the pneumatic tire 1 when the pneumatic tire 1 in the standard state is in contact with a flat surface with zero camber angle by being loaded with 70% of a standard tire load. Further, the tire tread width TW is the distance in the tire axial direction between a pair of the tread edges (Te). It should be noted that the center position in the axial direction between the tread edges (Te) is the tire equator (C). In the present embodiment, the tire equator (C) is located at the outermost position in the tire radial direction.

In the case where a standard included in a standardization system on which the pneumatic tire 1 is based has been established, the term “standard tire load” refers to a tire load specified for the concerned tire by the standard, for example, the “maximum load capacity” in JATMA, maximum value listed in “TIRE LOAD LIMITS AT VARIOUS COLD INFLATION PRESSURES” table in TRA, and “LOAD CAPACITY” in ETRTO. In the case where the standard included in the standardization system on which the pneumatic tire 1 is based has not been established, the standard tire load is the maximum load that can be applied to the pneumatic tire 1 and is determined by the manufacturer and the like.

It is preferred that each of the shoulder land regions 9B comes into contact with a flat plane when the pneumatic tire 1 is placed on the flat plane with zero camber angle by being loaded with 50% of the standard tire load. In the pneumatic tire 1 configured as such, the shoulder land regions 9B are in contact with the ground even when the load is relatively small, such as when a small bus is empty (i.e., no passengers), therefore, it is possible that uneven wear of the tread portion 2 is suppressed.

It is preferred that a camber amount LC at the outer edges (7e) in the tire axial direction is in the range from 2.5% to 12.5% of the maximum belt width WA. It should be noted that the camber amount LC at the positions of the outer edges (7e) is the distance in the tire radial direction between the tire equator (C) and the radial position of the outer edges (7e) in the tire profile.

Since the camber amount LC is 2.5% or more of the maximum belt width WA, the impact on the shoulder land regions 9B at the time of contact with the ground is mitigated, thereby, it is possible that the ride comfort performance is improved. Since the camber amount LC is 12.5% or less of the maximum belt width WA, the shoulder land regions 9B can be brought into contact with the ground even when the load applied is relatively small, therefore, it is possible that the uneven wear of the tread portion 2 is suppressed.

It is preferred that a distance LB in the tire axial direction between the inner edges (9e) of the shoulder land regions 9B is in the range from 25% to 95% of the maximum belt width WA. Since the distance LB between the inner edges (9e) is 25% or more of the maximum belt width WA, the shoulder land regions 9B are prevented from becoming excessively large, thereby, it is possible that the ride comfort performance during cornering is improved. Since the distance LB between the inner edges (9e) is 95% or less of the maximum belt width WA, the rigidity of the shoulder land regions 9B can be maintained, which makes it suitable for supporting heavy loads.

The belt layer 7 includes at least one, preferably two or more belt plies, and two belt plies 7A and 7B in the present embodiment. The belt plies 7A and 7B include a first belt ply 7A disposed on an inner side in the tire radial direction, and a second belt ply 7B disposed radially outside the first belt ply 7A, for example. The outer edges (7e) of the belt layer 7 in the present embodiment are the outer edges (7e) in the tire axial direction of the first belt ply 7A. The belt layer 7 configured as such can increase the rigidity of the tread portion 2 and is suitable for supporting a high load.

The belt plies 7A and 7B include belt cords (not shown) made of steel cords, for example. The belt cords may be single steel wires or may be stranded wires made of multiple steel filaments twisted together, for example.

The belt cords are arranged at an angle of 10 to 30 degrees with respect to the tire circumferential direction, for example. It is preferred that the belt cords of the first belt ply 7A are inclined to a side opposite to the belt cords of the second belt ply 7B with respect to the tire circumferential direction.

The belt layer 7 configured as such increases the rigidity of the tread portion 2 in a good balance, therefore, both the rigidity capable of supporting a heavy load and good ride comfort performance can be achieved. It should be noted that the angle of the belt cords mentioned above is the angle when the pneumatic tire 1 is in the standard state, which can be checked by partially peeling off the tread portion 2, for example.

The belt layer 7 includes an outermost belt ply disposed radially outermost among the belt plies. The outermost belt ply in the present embodiment is the second belt ply 7B. When the belt layer 7 includes only one belt ply 7A, for example, the first belt ply 7A is the outermost belt ply.

It is preferred that a belt width WB in the tire axial direction of the outermost belt ply is in the range from 80% to 100% of the maximum belt width WA. The belt layer 7 configured as such can achieve both the rigidity and weight reduction of the tread portion 2, and is useful for improving the ride comfort performance in a wide, small-diameter tire capable of supporting a heavy load.

As shown in FIG. 1, the carcass 6 includes at least one carcass ply, and two carcass plies 6A and 6B in the present embodiment. The two carcass plies 6A and 6B include a first carcass ply 6A disposed on an inner side in the tire radial direction and a second carcass ply 6B disposed radially outside the first carcass ply 6A in the tread portion 2, for example.

It is preferred that at least one of the carcass plies 6A and 6B includes a main body portion (6a) extending from the bead core 5 of one of the bead portions 4 to the bead core 5 of the other one of the bead portions 4 via the tread portion 2 and the sidewall portions 3, and turned up portions (6b) each turned up around a respective one of the bead cores 5 from the inside to the outside in the tire axial direction. Each of the first carcass ply 6A and the second carcass ply 6B in the present embodiment includes the main body portion (6a) and the turned up portions (6b).

It is preferred that at least one of the carcass plies 6A and 6B has outer ends (6e) in the tire radial direction of the turned up portions (6b) positioned radially outside the tire maximum width positions (P) where the tire section width SW is at its maximum.

In the present embodiment, the outer ends (6e) of the turned up portions (6b) of the first carcass ply 6A are located radially outward of the tire maximum width positions (P), and the outer ends (6e) of the turned up portions (6b) of the second carcass ply 6B are located radially inward of the tire maximum width positions (P). The carcass 6 configured as such can achieve both the rigidity and the weight reduction of the sidewall portions 3, and is useful for improving the ride comfort performance for a wide, small-diameter tire capable of supporting a heavy load.

The carcass plies 6A and 6B include carcass cords (not shown) made of organic fiber cords, for example. Examples of the organic fiber cords include cords made of one type of fibers or hybrid fibers made of two or more types of fibers selected from the group consisting of polyethylene terephthalate fiber, polyethylene naphthalate fiber, nylon fiber, aramid fiber, and rayon fiber, for example.

It is preferred that the carcass cords are arranged at an angle from 25 to 90 degrees with respect to the tire circumferential direction. It should be noted that the above-mentioned angle of the carcass cords is the angle when the pneumatic tire 1 is in the standard state, and can be confirmed by partially peeling off the tread portion 2, for example.

When the carcass cords are inclined at an angle of less than 90 degrees with respect to the tire circumferential direction, it is preferred that the carcass cords of the first carcass ply 6A and the carcass cords of the second carcass ply 6B are inclined to opposite sides to each other with respect to the tire circumferential direction. The carcass 6 may have a bias structure, for example.

It is preferred that tire section width SW is in the range from 145 to 285 mm. Since the tire section width SW is 145 mm or more, a large volume can be ensured in the tire inner cavity, thereby, it is possible that the ride comfort performance is improved. Since the tire section width SW is 285 mm or less, the tire weight is prevented from becoming excessively large, therefore, the ride comfort performance can be improved.

It is preferred that a ratio SH/SW of a tire section height SH to the tire section width SW is in the range from 35% to 75%. Since the ratio SH/SW is 35% or more, a large volume can be secured in the tire inner cavity, thereby, it is possible that the ride comfort performance is improved. Since the ratio SH/SW is 75% or less, excessive increase in the tire weight is suppressed, therefore, it is possible that the ride comfort performance is improved. It should be noted that the tire section height SH is a height in the tire radial direction from a bead base line BL to the tire equator (C). Further, the bead base line BL is an imaginary line that corresponds to the rim diameter RD. It should also be noted that the ratio SH/SW is a value generally known as the aspect ratio.

It is preferred that the rim width RW of the rim on which the pneumatic tire 1 is mounted is 9 inches or less. The pneumatic tire 1 configured as such suppresses the size of the rim, prevents the rim weight from becoming excessively large, and thus helps to improve the ride comfort performance.

It is preferred that the rim diameter RD of the rim on which the pneumatic tire 1 is mounted is in the range from 10 to 18 inches. Since the rim diameter RD is 10 inches or more, it is possible that the space inside the rim is ensured. Since the rim diameter RD is 18 inches or less, excessive increase in the rim weight and the tire weight can be prevented, therefore, it is possible that the ride comfort performance is improved.

While detailed description has been made of the pneumatic tire according to an especially preferred embodiment of the present disclosure, the present disclosure can be embodied in various forms without being limited to the illustrated embodiment.

### Examples

Pneumatic tires having the basic structure shown in FIG. 1 were made by way of test according to the specifications in Table 1. The ride comfort performance of the test pneumatic tires was evaluated. The main common specifications and test methods are as follows.

### <Common Specifications>

Tire size: 205/40R15
Rim size: 15×7.0 J
Tire inner pressure: 350 kPa
Test vehicle: small bus

### <Grip Performance>

The test tires were mounted on the test vehicle, and then a test driver evaluated the ride comfort performance based on a sensory perception of the test driver while the test driver alone drove the test vehicle on a dry asphalt road of a test course. The test results are indicated by an index based on Reference 1 being 100, wherein the higher the numerical value, the better the ride comfort performance is.

The test results are shown in Table 1.

TABLE 1

| | Ref. 1 | Ref. 2 | Ref. 3 | Ex. 1 | Ex. 2 | Ex. 3 | Ex. 4 | Ex. 5 |
|---|---|---|---|---|---|---|---|---|
| Rim width RW/Tire | 80 | 80 | 80 | 80 | 80 | 80 | 90 | 80 |
| section width SW [%] | | | | | | | | |
| Distance LA/Maximum | 11 | 11 | 33 | 11 | 22 | 11 | 11 | 11 |
| belt width WA [%] | | | | | | | | |
| Distance LA/Tire | 10 | 10 | 30 | 10 | 20 | 10 | 10 | 10 |
| section width WA [%] | | | | | | | | |
| Hardness (Hs) of | 75 | 80 | 65 | 65 | 65 | 70 | 65 | 65 |
| Tread rubber [degree] | | | | | | | | |
| Camber amount LC/ | 11 | 11 | 11 | 11 | 11 | 11 | 11 | 6 |
| Maximum belt width WA | | | | | | | | |
| [%] | | | | | | | | |
| Ride comfort performance | 100 | 98 | 100 | 104 | 106 | 102 | 104 | 102 |
| [index] | | | | | | | | |

From the test results, it was confirmed that the pneumatic tires in Examples had superior ride comfort performance compared to the pneumatic tires in References, and that the ride comfort performance can be improved for the pneumatic tires in the Examples as the wide, small-diameter tires capable of supporting high loads.

### [Statement of Disclosure]

The present disclosure includes the following aspects.

### [Present Disclosure 1]

A pneumatic tire configured to be mounted on a tire rim having a rim width RW, and including:
a tread portion;
a tire section width SW; and
an outer diameter from 350 to 600 mm,
wherein the tread portion includes a tread rubber forming a ground contact surface and having a hardness Hs, a belt layer disposed radially inside the tread rubber, and at least two circumferential grooves extending continuously and linearly in a tire circumferential direction,
the rim width RW is in the range from 78% to 99% of the tire section width SW,
the belt layer has outer edges in the tire axial direction, one outer edge on each axial side, and a maximum belt width WA in the tire axial direction,
the ground contact surface is divided into a plurality of land regions by the circumferential grooves,
the land regions include a pair of shoulder land regions each located on a respective axially outermost side,
each of the shoulder land regions includes an inner edge in the tire axial direction,
in an axial half of the pneumatic tire, the inner edge of the shoulder land region is located axially inside the outer edge of the belt layer,
in an axial half of the pneumatic tire, a distance LA in the tire axial direction between the inner edge of the shoulder land region and the outer edge of the belt layer is in the range from 10% to 30% of the maximum belt width WA of the belt layer,
the hardness Hs of the tread rubber satisfies the following Expression 1:

$$Hs \leq 75 - 20 \times \frac{LA}{SW} , \qquad ( Expression 1 )$$

where LA is a distance in millimeters between the inner edge of the shoulder land region and the outer edge of the belt layer in an axial half of the pneumatic tire, and SW is the tire section width in millimeters.

### [Present Disclosure 2]

The pneumatic tire according to Present Disclosure 1, wherein the tread portion is provided with two to four circumferential grooves.

### [Present Disclosure 3]

The pneumatic tire according to Present Disclosure 1 or 2, wherein the tire section width SW is in the range from 145 to 285 mm.

### [Present Disclosure 4]

The pneumatic tire according to any one of Present Disclosures 1 to 3, wherein the rim width RW is 9 inches or less.

### [Present Disclosure 5]

The pneumatic tire according to anu one of Present Disclosures 1 to 4, wherein the pneumatic tire is configured to be mounted on the tire rim having a rim diameter RD in the range from 10 to 18 inches.

### [Present Disclosure 6]

The pneumatic tire according to any one of Present Disclosures 1 to 5, wherein a ratio SH/SW of a tire section height SH to the tire section width SW is in the range from 35% to 75%.

### [Present Disclosure 7]

The pneumatic tire according to any one of Present Disclosures 1 to 6, wherein a distance LB in the tire axial direction between the inner edges of the shoulder land regions is in the range from 25% to 95% of the maximum belt width WA.

### [Present Disclosure 8]

The pneumatic tire according to any one of Present Disclosures 1 to 7, wherein the belt layer includes an outermost belt ply disposed outermost in the tire radial direction, and a belt width WB in the tire axial direction of the outermost belt ply is in the range from 80% to 100% of the maximum belt width WA.

### [Present Disclosure 9]

The pneumatic tire according to any one of Present Disclosures 1 to 8, wherein a camber amount LC at the outer edges of the belt layer is in the range from 2.5% to 12.5% of the maximum belt width WA.

### [Present Disclosure 10]

The pneumatic tire according to any one of Present Disclosures 1 to 9, wherein both of the shoulder land regions are configured to be in contact with a plane when the pneumatic tire is placed on the plane with zero camber angle by being loaded with 50% of a standard tire load.

### [Present Disclosure 11]

The pneumatic tire according to any one of Present Disclosures 1 to 10, wherein
the belt layer extends between tread edges across a tire equator, and
in an axial half of the pneumatic tire, the outer edge of the belt layer is located axially outside the tread edge.

### [Present Disclosure 12]

The pneumatic tire according to any one of Present Disclosures 1 to 11, wherein
the belt layer includes a first belt ply and a second belt ply disposed radially outside the first belt ply, and
the outer edges of the belt layer are outer edges in the tire axial direction of the first belt ply.

### [Present Disclosure 13]

The pneumatic tire according to Present Disclosure 12, wherein
the first belt ply and the second belt ply extend between tread edges across a tire equator,
in an axial half of the pneumatic tire, the outer edge of the first belt ply is located axially outside an outer edge in the tire axial direction of the second belt ply.

### [Present Disclosure 14]

The pneumatic tire according to Present Disclosure 13, wherein
in an axial half of the pneumatic tire,
the outer edge of the first belt ply is located axially outside the tread edge, and
the outer edge of the second belt ply is not located axially outside the tread edge.

### [Present Disclosure 15]

The pneumatic tire according to any one of Present Disclosures 1 to 14 further including:
a pair of sidewall portions;
a pair of bead portions each having a bead core embedded therein; and
a carcass extending between the bead portions,
each of the sidewall portions extends radially inward from a respective axial end of the tread portion,
each of the bead portions is arranged radially inside a respective one of the sidewall portions,
the carcass includes one or more carcass plies,
the one or more carcass plies include a main body portion and a pair of turned up portions continuous with the main body portion,
the main body portion extends from the bead core of one of the bead portions to the bead core of the other one of the bead portions via the tread portion and the sidewall portions,
each of the turned up portions is turned up around a respective one of the bead cores from the inside to the outside in the tire axial direction, and
the turned up portions have outer ends in the tire radial direction located radially outward of tire maximum width positions where the tire section width SW is at its maximum.

### [Present Disclosure 16]

The pneumatic tire according to Present Disclosure 15, wherein
the carcass includes a plurality of the carcass plies,
the carcass plies include a first carcass ply and a second carcass ply arranged radially outside the first carcass ply,
each of the first carcass ply and the second carcass ply has the main body portion and the turned up portions,
the outer ends of the turned up portions of the first carcass ply are located radially outside the tire maximum width positions, and
the outer ends of the turned up portions of the second carcass ply are located radially inside the tire maximum width positions.

### [Present Disclosure 17]

The pneumatic tire according to any one of Present Disclosures 1 to 16, wherein
the tread portion is provided with two circumferential grooves,
the land regions consist of the shoulder land regions and a crown land region demarcated between the two circumferential grooves, and
each of the shoulder regions is demarcated axially outside a respective one of the circumferential grooves.

### [Present Disclosure 18]

The pneumatic tire according to any one of Present Disclosures 1 to 17, wherein
the hardness Hs of the tread rubber is from 65 to 70 degrees, and
the hardness Hs is a hardness measured by a type-A durometer in an environment of 23 degrees Celsius in accordance with Japanese Industrial Standard JIS-K6253.

### [Present Disclosure 19]

The pneumatic tire according to Present Disclosure 18, wherein the distance LA is from 11% to 22% of the maximum belt width WA.

### [Present Disclosure 20]

The pneumatic tire according to Present Disclosure 19, wherein the distance LA is from 10% to 20% of the tire section width SW.

### DESCRIPTION OF REFERENCE SIGNS

1 pneumatic tire
2 tread portion
2G tread rubber
2s ground contact surface
7 belt layer
7e outer edge
8 circumferential groove
9 land region
9B shoulder land region
9e inner edge

1. A pneumatic tire configured to be mounted on a tire rim having a rim width RW, and comprising:
a tread portion;
a tire section width SW; and
an outer diameter from 350 to 600 mm,
wherein the tread portion includes a tread rubber forming a ground contact surface and having a hardness Hs, a belt layer disposed radially inside the tread rubber, and at least two circumferential grooves extending continuously and linearly in a tire circumferential direction,
the rim width RW is in the range from 78% to 99% of the tire section width SW,
the belt layer has outer edges in the tire axial direction, one outer edge on each axial side, and a maximum belt width WA in the tire axial direction,
the ground contact surface is divided into a plurality of land regions by the circumferential grooves,
the land regions include a pair of shoulder land regions each located on a respective axially outermost side,
each of the shoulder land regions includes an inner edge in the tire axial direction,
in an axial half of the pneumatic tire, the inner edge of the shoulder land region is located axially inside the outer edge of the belt layer,
in an axial half of the pneumatic tire, a distance LA in the tire axial direction between the inner edge of the shoulder land region and the outer edge of the belt layer is in the range from 10% to 30% of the maximum belt width WA of the belt layer,
the hardness Hs of the tread rubber satisfies the following Expression 1:
$$Hs \leq 75 - 20 \times \frac{LA}{SW} , \qquad ( Expression 1 )$$
where LA is a distance in millimeters between the inner edge of the shoulder land region and the outer edge of the belt layer in an axial half of the pneumatic tire, and
SW is the tire section width in millimeters.

2. The pneumatic tire according to claim 1, wherein the tread portion is provided with two to four circumferential grooves.

3. The pneumatic tire according to claim 1, wherein the tire section width SW is in the range from 145 to 285 mm.

4. The pneumatic tire according to claim 1, wherein the rim width RW is 9 inches or less.

5. The pneumatic tire according to claim 1, wherein the pneumatic tire is configured to be mounted on the tire rim having a rim diameter RD in the range from 10 to 18 inches.

6. The pneumatic tire according to claim 1, wherein a ratio SH/SW of a tire section height SH to the tire section width SW is in the range from 35% to 75%.

7. The pneumatic tire according to claim 1, wherein a distance LB in the tire axial direction between the inner edges of the shoulder land regions is in the range from 25% to 95% of the maximum belt width WA.

8. The pneumatic tire according to claim 1, wherein the belt layer includes an outermost belt ply disposed outermost in the tire radial direction, and
a belt width WB in the tire axial direction of the outermost belt ply is in the range from 80% to 100% of the maximum belt width WA.

9. The pneumatic tire according to claim 1, wherein a camber amount LC at the outer edges of the belt layer is in the range from 2.5% to 12.5% of the maximum belt width WA.

10. The pneumatic tire according to claim 1, wherein both of the shoulder land regions are configured to be in contact with a plane when the pneumatic tire is placed on the plane with zero camber angle by being loaded with 50% of a standard tire load.

11. The pneumatic tire according to claim 1, wherein
the belt layer extends between tread edges across a tire equator, and
in an axial half of the pneumatic tire, the outer edge of the belt layer is located axially outside the tread edge.

12. The pneumatic tire according to claim 1, wherein
the belt layer includes a first belt ply and a second belt ply disposed radially outside the first belt ply, and
the outer edges of the belt layer are outer edges in the tire axial direction of the first belt ply.

13. The pneumatic tire according to claim 12, wherein
the first belt ply and the second belt ply extend between tread edges across a tire equator,
in an axial half of the pneumatic tire, the outer edge of the first belt ply is located axially outside an outer edge in the tire axial direction of the second belt ply.

14. The pneumatic tire according to claim 13, wherein
in an axial half of the pneumatic tire,
the outer edge of the first belt ply is located axially outside the tread edge, and
the outer edge of the second belt ply is not located axially outside the tread edge.

15. The pneumatic tire according to claim 1 further comprising:
a pair of sidewall portions;
a pair of bead portions each having a bead core embedded therein; and
a carcass extending between the bead portions,
each of the sidewall portions extends radially inward from a respective axial end of the tread portion,
each of the bead portions is arranged radially inside a respective one of the sidewall portions,
the carcass includes one or more carcass plies,
the one or more carcass plies include a main body portion and a pair of turned up portions continuous with the main body portion,
the main body portion extends from the bead core of one of the bead portions to the bead core of the other one of the bead portions via the tread portion and the sidewall portions,
each of the turned up portions is turned up around a respective one of the bead cores from the inside to the outside in the tire axial direction, and
the turned up portions have outer ends in the tire radial direction located radially outward of tire maximum width positions where the tire section width SW is at its maximum.

16. The pneumatic tire according to claim 15, wherein
the carcass includes a plurality of the carcass plies,
the carcass plies include a first carcass ply and a second carcass ply arranged radially outside the first carcass ply,
each of the first carcass ply and the second carcass ply has the main body portion and the turned up portions,
the outer ends of the turned up portions of the first carcass ply are located radially outside the tire maximum width positions, and
the outer ends of the turned up portions of the second carcass ply are located radially inside the tire maximum width positions.

17. The pneumatic tire according to claim 1, wherein
the tread portion is provided with two circumferential grooves,
the land regions consist of the shoulder land regions and a crown land region demarcated between the two circumferential grooves, and
each of the shoulder regions is demarcated axially outside a respective one of the circumferential grooves.

18. The pneumatic tire according to claim 1, wherein
the hardness Hs of the tread rubber is from 65 to 70 degrees, and
the hardness Hs is a hardness measured by a type-A durometer in an environment of 23 degrees Celsius in accordance with Japanese Industrial Standard JIS-K6253.

19. The pneumatic tire according to claim 18, wherein the distance LA is from 11% to 22% of the maximum belt width WA.

20. The pneumatic tire according to claim 19, wherein the distance LA is from 10% to 20% of the tire section width SW.
